(19) United States
(12) Patent Application Publication
(10) Pub. No.: US 2026/0290134 A1
(43) Pub. Date: Sep. 24, 2026

(54) LOTTERY TICKET SELLING SYSTEM HAVING A LOTTERY TICKET SCANNING ASSEMBLY THAT PROCESSES CONNECTED DRAW LOTTERY TICKETS PRINTED BY A DRAW LOTTERY TICKET PRINTER OF THE SYSTEM

(71) Applicant: Brightstar Global Solutions Corporation, Providence, RI (US)

(72) Inventor: Robert Corvese, Warwick, RI (US)

(21) Appl. No.: 19/084,183

(22) Filed: Mar. 19, 2025

(51) Int. Cl. G07F 17/42; A63F 3/06; B41J 3/30; B41J 3/44; B41J 3/46; H04N 1/00

(52) U.S. Cl. CPC G07F 17/42; A63F 3/0655; B41J 3/30; B41J 3/445; B41J 3/46; H04N 1/00591

(57) ABSTRACT

Lottery ticket selling systems and methods of operating the systems that enable the purchases of draw lottery tickets and includes an electronic ticket courier server, a wager details display device, a lottery terminal with a scanner, a draw lottery ticket printer positioned to sequentially print a plurality of draw lottery tickets on an elongated sheet of a paper such that the plurality of draw lottery tickets are connected draw lottery tickets, and a draw lottery ticket scanning assembly comprising: a draw lottery ticket feeder positioned to receive the connected draw lottery tickets from the draw lottery ticket printer, a draw lottery ticket scanner positioned to sequentially receive from the draw lottery ticket feeder and scan each of the draw lottery tickets of the connected draw lottery tickets, and a draw lottery ticket rewinder positioned to receive from the draw lottery ticket scanner each of the draw lottery tickets of the connected draw lottery tickets and to rewind the connected draw lottery tickets on a storage spool.

### BACKGROUND

The present disclosure relates to a lottery ticket selling system having a lottery ticket printer scanning assembly that processes connected draw lottery tickets printed by a lottery ticket printer of the system.

For a draw lottery ticket for a draw lottery game, a player may select the player numbers or may have an electronic lottery system randomly select the player numbers (which is often referred to as a quick pick). Draw lottery tickets may be purchased in variety of different manners using a variety of different systems such as systems that include lottery terminals. Various different jurisdictions (such as states) have different rules regarding how such draw lottery tickets can be purchased.

### BRIEF SUMMARY

In various embodiments, the present disclosure relates to a lottery ticket selling system comprising: an electronic ticket courier server; a wager details display device; a lottery terminal with a scanner; a draw lottery ticket printer positioned to sequentially print a plurality of draw lottery tickets on an elongated sheet of a paper such that the plurality of draw lottery tickets are connected draw lottery tickets; and a draw lottery ticket scanning assembly. The draw lottery ticket scanning assembly comprises: a draw lottery ticket feeder positioned to receive the connected draw lottery tickets from the draw lottery ticket printer, a draw lottery ticket scanner positioned to sequentially receive from the draw lottery ticket feeder and scan each of the draw lottery tickets of the connected draw lottery tickets, and a draw lottery ticket rewinder positioned to receive from the draw lottery ticket scanner each of the draw lottery tickets of the connected draw lottery tickets and to rewind the connected draw lottery tickets on a storage spool.

In various other embodiments, the present disclosure relates to a lottery ticket a lottery ticket selling system comprising: an electronic ticket courier server; a wager details display device; a lottery terminal with a scanner; a draw lottery ticket printer positioned to sequentially print a plurality of draw lottery tickets on an elongated sheet of a paper such that the plurality of draw lottery tickets are connected draw lottery tickets; and a draw lottery ticket scanning assembly. The draw lottery ticket scanning assembly comprises a draw lottery ticket feeder, a draw lottery ticket scanner, and a draw lottery ticket rewinder. The draw lottery ticket feeder is positioned to receive the connected draw lottery tickets from the draw lottery ticket printer. The draw lottery ticket feeder comprises a frame, a plurality of rotatable non-driven guide rollers supported by the frame, a plurality of rotatable drive rollers supported by the frame, and a plurality of stationary guides supported by the frame. The draw lottery ticket scanner comprises a scanner housing and a digital camera supported by the scanner housing, the draw lottery ticket scanner positioned to sequentially receive from the draw lottery ticket feeder and scan each of the connected draw lottery tickets. The draw lottery ticket rewinder comprises a base, a support connected to and extending upwardly from the base, a drive motor supported by the support, and a rotatable spool holder connected to and supported by the drive motor. The draw lottery ticket rewinder is positioned to receive from the draw lottery ticket scanner each of the connected draw lottery tickets and to rewind each of the connected draw lottery tickets on a storage spool.

In various other embodiments, the present disclosure relates to a lottery ticket selling system comprising: an electronic ticket courier server; a wager details display device; a lottery terminal with a scanner; a draw lottery ticket printer positioned to sequentially print a plurality of draw lottery tickets on an elongated sheet of a paper such that the plurality of draw lottery tickets are connected draw lottery tickets; and a draw lottery ticket scanning assembly. The draw lottery ticket scanning assembly comprises: a draw lottery ticket feeder, a draw lottery ticket scanner, and a draw lottery ticket rewinder. The draw lottery ticket printer, the draw lottery ticket feeder, the draw lottery ticket scanner, and the draw lottery ticket rewinder are positioned to cause each sequentially printed connected draw lottery ticket to be: fed into the draw lottery ticket feeder, maintained in the ticket feeder until the draw lottery ticket scanner is ready to receive that printed lottery ticket, fed into the draw lottery ticket scanner after the draw lottery ticket scanner is ready to receive that draw lottery ticket, stopped in the draw lottery ticket scanner to enable the draw lottery ticket scanner to obtain an image of that printed draw lottery ticket, fed out of the draw lottery ticket scanner after the draw lottery ticket is scanned, and fed to the draw lottery ticket rewinder such that the draw lottery ticket rewinder can wind the draw lottery ticket on a removable storage spool.

Additional features are described in, and will be apparent from, the following Detailed Description and the figures.

### BRIEF DESCRIPTION OF THE SEVERAL VIEWS OF THE DRAWINGS

FIG. 1 is front view of an example draw lottery ticket.

FIG. 2 is a diagrammatic view of a known lottery ticket selling system.

FIG. 3 is a diagrammatic perspective view of an example lottery ticket selling system having a draw lottery ticket scanning assembly that processes connected draw lottery tickets printed by a draw lottery ticket printer of the system in accordance with one example embodiment of the present disclosure.

FIG. 3A is an enlarged perspective view of part of an example draw lottery ticket feeder that can be part of the draw lottery ticket scanning assembly of the lottery ticket selling system of FIG. 3.

FIG. 3B is an enlarged perspective view of an example draw ticket scanner that can be part of the draw lottery ticket scanning assembly of the lottery ticket selling system of FIG. 3.

FIG. 3C is an enlarged perspective view of an example draw lottery ticket rewinder that can be part of the draw lottery ticket scanning assembly of the lottery ticket selling system of FIG. 3.

### DETAILED DESCRIPTION

In various embodiments, the present disclosure relates to a lottery ticket selling system and method of operating the lottery ticket selling system. The lottery ticket selling system includes a draw lottery ticket scanning assembly that processes connected draw lottery tickets printed by a draw lottery ticket printer on sheet of paper. The draw lottery ticket scanning assembly controls the movements of the connected printed draw lottery tickets from the draw lottery ticket printer and into a draw lottery ticket scanner, causes the draw lottery ticket scanner to scan each of the printed draw lottery tickets, controls the movements of the connected printed draw lottery tickets from the draw lottery ticket scanner to a draw lottery ticket rewinder, winds the scanned connected draw lottery tickets on a storage spool held by the draw lottery ticket rewinder, and transmits the printed lottery ticket data based on the scanned draw lottery tickets.

Draw lottery tickets for draw lottery games are employed as example lottery tickets herein; however, it should be appreciated that the present disclosure is not meant to be limited by such examples.

For a better understanding of the present disclosure, an example draw lottery ticket is first described herein.

A draw lottery ticket can include: (1) a single set of player numbers for a single play of a draw lottery game; (2) multiple sets of player numbers for a single play of a draw lottery game; (3) a single set of player numbers for each of multiple plays of a draw lottery game; or (4) multiple sets of player numbers for each of multiple plays of a draw lottery game. For simplicity, the present disclosure uses a draw lottery ticket with a single set of player numbers for a single play of a draw lottery game as an example, but it should be appreciated that the present disclosure can be employed for selling various other draw lottery tickets.

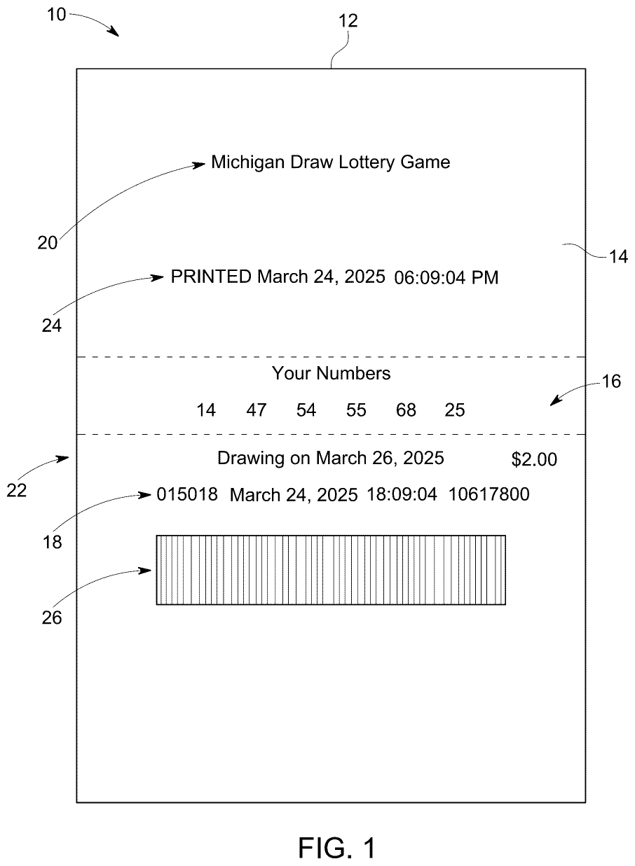

An example physical draw lottery ticket 10 is shown in FIG. 1. This example draw lottery ticket includes: (1) a ticket substrate 12; (2) a front surface 14 of the ticket substrate 12; (3) lottery ticket information, including a single set of player numbers (for a single play of draw lottery game), printed on the front surface 14 of the ticket substrate 12; and (4) a back surface (not shown) of the ticket substrate 12. This example draw lottery ticket 10 is for a single play of a draw lottery game (scheduled to take place on Wednesday Mar. 26, 2025) and includes a single set of player numbers 16 (i.e., player numbers for the single play of the draw lottery game). The lottery ticket information in this example includes player numbers 16, a ticket identifier 18 that uniquely identifies the lottery ticket 10, a game identifier 20 that identifies the lottery game type, a draw date 22 associated with the ticket 10, and a print date 24 on which the ticket 10 was printed. The lottery ticket information can include text, a ticket number such as the ticket identifier 18, a ticket barcode such as barcode 26, and other lottery ticket information that is in either or both human readable and machine-readable forms. The lottery ticket's barcode 26 is configured to be scanned by a barcode reading device to enable redemption of this draw lottery ticket.

Additionally, for a better understanding of the present disclosure, an example known system and method employed for selling draw lottery tickets is also now described.

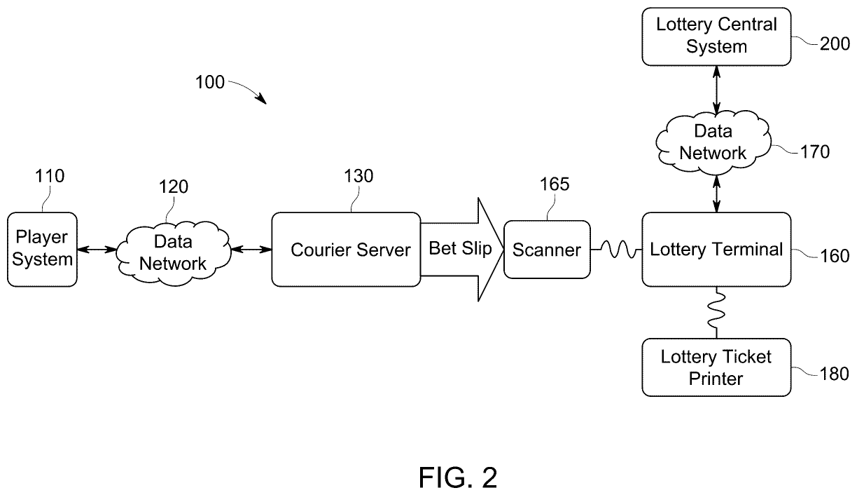

In various jurisdictions (such as states) that do not permit the remote electronic purchase of draw lottery tickets (such as via a website), a lottery ticket system 100 using a courier service has been employed. Turning to FIG. 2, the system 100 includes: (a) a player system 110 with a courier mobile application downloaded thereon; (b) a courier server 130; (c) a lottery terminal 160; (d) a scanner 165 associated with the lottery terminal 160; (e) a lottery ticket printer 180; and (f) a central lottery server 200. The player system 110 and the courier server 130 are configured to communicate with each other via a suitable data network 120 such as a cellular data network or the Internet. The lottery terminal 160 and the scanner 165 are configured to communicate with each other via hard wire such as an USB connector. The lottery terminal 160 and the lottery ticket printer 180 are configured to communicate with each other via hard wire such as an USB connector. The lottery terminal 160 and the lottery central system 200 are configured to communicate with each other via a suitable data network 170 such as a cellular data network, the Internet, or lottery router and a private secure network.

The player system 110 includes a player electronic device such as a smartphone with the courier mobile application downloaded thereon. The courier server 130 includes a server configured to receive draw lottery game bet details from the player system 110 via the courier mobile application and to generate a suitable bet for the play of the draw lottery game based on the bet details. The bet includes a player's selected numbers or a player's quick pick numbers for a selected play of a selected draw lottery game. The courier server 130 can cause a bet slip to be printed such that the bet slip can be scanned by the scanner 165. A human courier processing clerk takes the physical printed paper bet slip for the play of the draw lottery game to the lottery terminal 160 to scan the physical printed paper bet slip. The scanner 165 scans the bet slip and the lottery terminal 160 uses that bet slip scan data to determine the player numbers for the play of the draw lottery game and to create the draw lottery ticket for the player. The lottery terminal 160 causes the lottery ticket printer 180 to print out the draw lottery ticket with the player numbers. The operator of the lottery terminal 160 also collects the payment for the draw lottery ticket from the courier processing clerk and provides the printed draw lottery ticket to the courier processing clerk. The courier processing clerk then takes the physical printed bet slip and the physical printed draw lottery ticket back to the courier processing center. The courier processing clerk scans the physical printed lottery ticket using a courier scanning system (not shown) connected to the courier server 130. The courier server 130 links the scanned draw lottery ticket back to a player account established through the courier mobile application. The courier server 130 then makes the scanned lottery ticket available for the player to view via the courier mobile application on the player system 110. The courier processing clerk places the physical printed bet slip and the physical printed lottery ticket in secure courier storage locations for storage if needed at a later time.

After the draw for the play of the draw lottery game takes place, if the player's draw lottery ticket is a winning lottery ticket and the winning amount is less than $600, the courier server automatically credits the winning amount for the player's draw lottery ticket to the player's account. The courier service can then retrieve and redeem the stored actual winning physical printed draw lottery ticket at a location having a lottery terminal. After the draw for the draw lottery game takes place, if the player's draw lottery ticket is a winning draw lottery ticket and the winning amount is $600 or more, a courier processing clerk retrieves the stored winning physical player draw lottery ticket from the courier storage location and provides that physical printed draw lottery ticket to the player so that the player can cash in that draw lottery ticket and obtain the winning amount.

The present disclosure is configured to be employed with various improvements to the courier system described above.

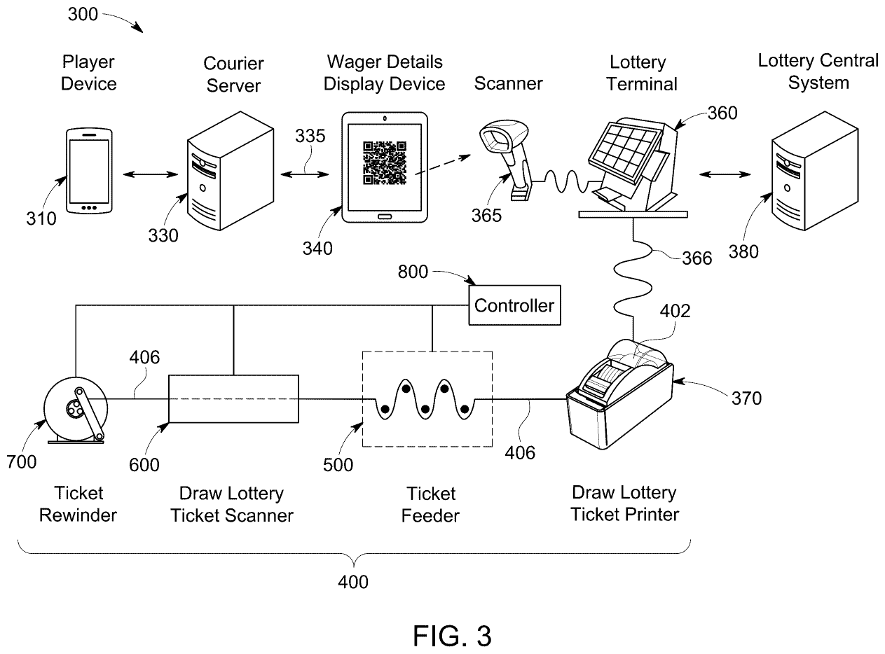

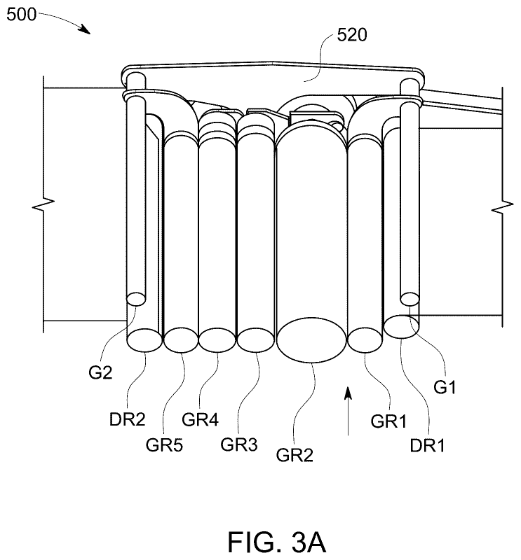

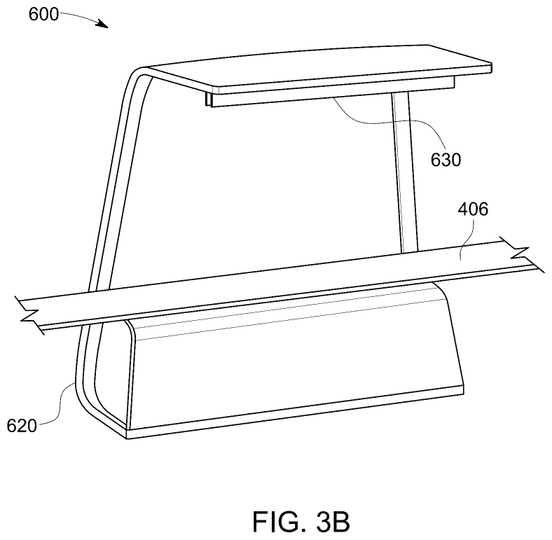

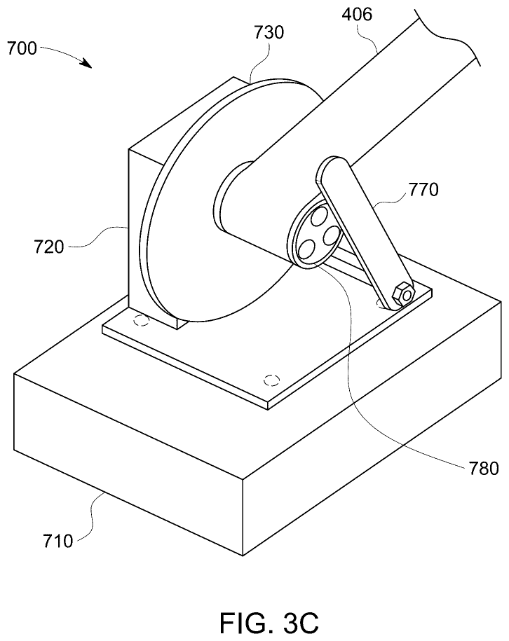

FIG. 3 shows an example lottery ticket selling system 300 in accordance with one example embodiment of the present disclosure is generally shown.

FIGS. 3A, 3B, and 3C respective show an example draw lottery ticket feeder 500, an example draw ticket scanner 600, and example draw lottery ticket rewinder 700 that can be part of the draw lottery ticket scanning assembly of the lottery ticket selling system of FIG. 3.

This illustrated example lottery ticket selling system 300 includes: (a) a player electronic device 310 with a courier mobile application downloaded thereon; (b) an electronic ticket courier server 330; (c) a wager details display device 340; (d) a lottery terminal 360 with a scanner 365; (e) a draw lottery ticket printer 370; (f) a lottery central system 380; and (g) a draw lottery ticket scanning assembly 400. The draw lottery ticket scanning assembly 400 includes: (a) a draw lottery ticket feeder 500; (b) a draw lottery ticket scanner 600; (c) a draw lottery ticket rewinder 700; and (d) a controller 800. The draw lottery ticket feeder 500, the draw lottery ticket scanner 600, and the draw lottery ticket rewinder 700 are shown diagrammatically in FIG. 3. Examples of the draw lottery ticket feeder 500, the draw lottery ticket scanner 600, and the draw lottery ticket rewinder 700 are shown in FIGS. 3A, 3B, and 3C; however, it should be appreciated that each of these components can vary in accordance with the present disclosure.

In this illustrated example embodiment, the electronic player device 310 and the courier server 330 are configured to communicate with each other via a suitable data network 320.

In this illustrated example embodiment, the courier server 330 and the wager details display device 340 are configured to communicate with each other via a hard wire connection such as a USB connector 335. In other embodiments, the communication between these components can be via wireless connection such as Bluetooth, or other suitable data connection such as via a suitable data network (such as but not limited to a cellular data network or the Internet).

In this illustrated example embodiment, the lottery terminal 360 and the draw lottery ticket printer 370 are configured to communicate with each other via hard wire 366. In other embodiments, the communication between these components can be via a suitable data network.

In this illustrated example embodiment, the lottery terminal 360 and the draw lottery ticket printer 370 are configured to communicate with each other via hard wire 366. In other embodiments, the communication between these components can be via a suitable data network.

In this illustrated example embodiment, the lottery terminal 360 and the lottery central system 385 are configured to communicate with each other via a suitable data network 370 such as a secure data network.

In this illustrated example embodiment, the controller 800 of the draw lottery ticket scanning assembly 400 is configured to communicate with one or more or each of the components of the lottery ticket scanning assembly 400 via hard wires. In other embodiments, the communication between these components can be via a suitable data network.

The draw lottery ticket printer 370 does not separate each of the draw lottery tickets printed on the lottery ticket printer paper but rather maintains each sequentially printed draw lottery ticket connected together on an elongated single sheet 406 that is rolled onto a storage spool 780 by the draw lottery ticket rewinder 700 for storage and potential later access. In other words, the draw lottery ticket rewinder 700 is configured to receive the connected printed draw lottery tickets from the draw lottery ticket printer 370 and wind the connected printed draw lottery tickets on the storage spool 800 for storage.

The draw lottery ticket scanning assembly 400 is configured to sequentially receive each of the connected printed draw lottery tickets from the draw lottery ticket printer 370, control the movement of each draw lottery ticket, scan each of the connected printed draw lottery tickets, and transmit scanned draw lottery ticket data to the courier server 330, and wind each connected printed draw lottery tickets on a storage spool to enable storage of such draw lottery tickets.

More specifically, the lottery ticket selling system 300, for each of a plurality of draw lottery tickets: (1) enables a purchaser to employ a player electronic device such as player electronic device 310 to purchase a draw lottery ticket; (2) causes the player electronic device 310 to send an order including the wager details for the purchase of a draw lottery ticket to the courier server 330; (3) causes the courier server 330 to generate a wager details code (such as a QR code) based on the wager details for the ordered draw lottery ticket to be purchased; (4) causes the courier server 330 to cause the wager details display device 340 to display the wager details code to enable scanning of the wager details code by a scanner 365 of the lottery terminal 360 to enable the lottery terminal 360 to obtain the wager details for the ordered draw lottery ticket to be purchased; (5) causes generation of the draw lottery ticket based on the wager details; (6) generates and sends the draw lottery ticket data for the draw lottery ticket to the lottery central server 380; (7) causes the draw lottery ticket printer 370 to print the purchased draw lottery ticket on a section of a sheet of paper from a supply spool 402 of lottery ticket printer paper supported by the draw lottery ticket printer 370; (8) causes the printed draw lottery ticket on the sheet of connected draw lottery tickets 406 to be feed into a ticket feeder 500; (9) causes the printed draw lottery ticket on the connected sheet of draw lottery tickets 406 to be maintained in the ticket feeder 500 until the draw lottery ticket scanner 600 is ready to receive that printed lottery ticket; (10) causes the printed draw lottery ticket on the sheet of draw lottery tickets 406 to be feed into the draw lottery ticket scanner 600 when the ticket scanner 600 is ready to receive that printed lottery ticket; (11) causes the movement of the printed draw lottery ticket on the sheet of draw lottery tickets 406 (and that section of the sheet of draw lottery tickets) to stop moving to enable the draw lottery ticket scanner 600 to obtain a clear image of that printed draw lottery ticket; (12) causes the draw lottery ticket scanner 600 to scan the printed lottery ticket; (13) causes the draw lottery ticket scanner 600 to create and send printed lottery ticket scan data to the courier server 330 to enable the courier server 330 to provide such image of the purchased and printed draw lottery ticket to the purchaser of the draw lottery ticket; (14) causes the printed draw lottery ticket on the sheet of draw lottery tickets 406 to be feed out of the ticket scanner 600 after the printed draw lottery ticket is scanned; and (15) causes the printed draw lottery ticket on the sheet of draw lottery tickets to be feed to the draw lottery ticket rewinder 700 such that the draw lottery ticket rewinder 700 winds the printed draw lottery ticket on a removable storage spool 780 supported by the draw lottery ticket rewinder 700.

The present disclosure ensures that each printed draw lottery ticket that forms the sheet of draw lottery tickets 406 is properly scanned and wound on the storage spool 780. More specifically, the present disclosure addresses the specific issue relating to the different potential speeds of the draw lottery ticket printing by the draw lottery ticket printer 370 and the draw lottery ticket scanning of each printed draw lottery ticket by the draw lottery ticket scanner 600.

In particular, in various instances, the draw lottery ticket printer 370 can: (1) continuously print draw lottery tickets on the elongated sheet from the supply roll 402; (2) print and stop printing draw lottery tickets on the elongated sheet from the supply roll 402 on a regular basis; and (3) print and stop printing draw lottery tickets on the elongated sheet from the supply roll 402 on a irregular basis. Thus, the rate that the connected draw lottery tickets 406 exits the draw lottery ticket printer 370 can significantly vary.

On the other hand, the rate that the draw lottery ticket scanner 600 can scan each of the connected printed draw lottery tickets is static and specifically, the draw lottery ticket must be correctly positioned in the draw lottery ticket scanner 600, stopped to allow for the scanning of that draw lottery ticket by the draw lottery ticket scanner 600, and then moved out of the draw lottery ticket scanner 600.

The draw lottery ticket scanning assembly 400 including the draw lottery ticket feeder 500, the draw lottery ticket scanner 600, the draw lottery ticket rewinder 700, and the controller 800 account for this and particularly precisely control the movement of each of the connected draw lottery tickets into and out of the draw lottery ticket scanner 600 and onto the rewinder 700. In various embodiments, the controller 800 controls the operation of one of more of the components of the draw lottery ticket scanning assembly 400 to effectuate these precise movements.

The draw lottery ticket feeder 500 of this example embodiment of the present disclosure includes: (a) a suitable frame 520; (b) one or more rotatable non-driven guide rollers (such as but not limited to guide rollers GR1, GR2, GR3, GR4, and GR5) suitably supported by the frame 520; (c) one or more rotatable drive rollers (such as but not limited to drive rollers DR1 and DR2) suitably supported by the frame 520; and (4) one or more stationary guides (such as but not limited to guides G1 and G2) supported by the frame 520.

The quantity of the rotatable non-driven guide rollers, the quantity of rotatable drive rollers, and the quantity of stationary guides of the draw lottery ticket feeder can vary in accordance with the present disclosure.

The relative positions of each of the rotatable non-driven guide rollers, the rotatable drive rollers, and the stationary guides of the draw lottery ticket feeder can vary in accordance with the present disclosure.

The relative outer diameters of each of the rotatable non-driven guide rollers, the rotatable drive rollers, and the stationary guides of the draw lottery ticket feeder can vary in accordance with the present disclosure.

In various embodiments, the rotatable non-driven guide rollers, the rotatable drive rollers, and the stationary guides of the draw lottery ticket feeder 500 co-act to receive, guide, and take up slack as needed for the connected draw lottery tickets.

In various embodiments, the frame 520 is configured to move one or more of the rotatable non-driven guide rollers, the rotatable drive rollers, and/or the stationary guides relative to one or more of the other rotatable non-driven guide rollers, the other rotatable drive rollers, and/or the other stationary guides to receive, guide, and take up slack as needed in the sheet of connected draw lottery tickets 406.

In various embodiments, the frame 520 includes two or more components that support the rotatable non-driven guide rollers, the rotatable drive rollers, and/or the stationary guides, and wherein the components are configured to move relative to each other to cause the rotatable non-driven guide rollers, the rotatable drive rollers, and/or the stationary guides to receive, guide, and take up slack as needed in the sheet of connected draw lottery tickets 406.

In various embodiments such as shown in FIG. 3, the draw lottery ticket scanning assembly 400 includes a single draw lottery ticket feeder 500.

In various embodiments, the draw lottery ticket scanning assembly 400 can include multiple draw lottery ticket feeders such as one upstream of the draw lottery ticket scanner 600 and one downstream of the draw lottery ticket scanner 600. Downstream means the direction of travel of the connected draw lottery tickets 406 from the draw lottery ticket printer 370 to the draw lottery ticket rewinder 700. Upstream means the direction opposite the direction of travel of the connected draw lottery tickets 406.

In various embodiments, the draw lottery ticket feeder 500 can individually and independently rotate the drive rollers DR1 and DR2 at controlled and varying speeds to receive, guide, and take up slack as needed in the sheet of connected draw lottery tickets 406.

The draw lottery ticket scanner 600 includes: (a) a scanner housing 620; (b) a digital camera 630 supported by the scanner housing 620; (c) a controller (not shown) supported by the scanner housing 620; (d) a transmitter (not shown) supported by the scanner housing 620; and (e) one or more additional electrical or mechanical components (not shown) such as an on/off switch (not shown) supported by the scanner housing 620. These electrical components are suitably electrically connected by the additional electrical components. Generally, these components and other suitable electrical and mechanical components are arranged or configured and electrically and/or mechanically connected such that the draw lottery ticket scanner 600 can take a clear picture of each printed draw lottery ticket that is positioned under the digital camera 630 and send out printed draw lottery ticket data. Such data is sent to the courier server 330 in various embodiments.

In various other embodiments, the draw lottery ticket scanner 600 can include a code reader that is configured to scan the code (such as a barcode or QR code) printed on each the draw lottery ticket.

The transmitter of the draw lottery ticket scanner 600 can be or include any suitable type of transmitting device. In certain embodiments of the present disclosure, the transmitter is configured to only send out signals. In other embodiments of the present disclosure, the transmitter is configured to send out and receive signals from the courier server 330. In other embodiments of the present disclosure, the transmitter includes a signal receiver (not shown) and a separate signal transmitter (not shown). In various embodiments, the draw lottery ticket scanner 600 is configured to communicate with the courier server 330 through one or more wires that are plugged into or otherwise attached to the lottery ticket scanning assembly 400 and the courier server 300.

In other embodiments of the present disclosure, lottery ticket scanner 600 includes two digital cameras that take respective images of each of the top and bottom faces of each draw lottery ticket and that sends out printed draw lottery ticket data including both of those images for each scanned draw lottery ticket.

In various embodiments of the present disclosure, lottery ticket scanner 600 can additionally or alternatively read codes such as the barcodes on the scanned draw lottery ticket images or do ORC on the printed text on the draw lottery ticket. This data would be sent to the courier server 330 along with the image data.

The draw lottery ticket rewinder 700 includes: (1) a base 710; (2) a support 720 connected to and extending upwardly from the base 710; (3) an electric drive motor (not shown) supported by the support 720; (4) a rotatable spool holder 730 connected to and supported by the drive motor; (5) one or more paper guide assemblies such as paper guide assembly 770 supported by the base 710 and configured to guide the sheet of connected draw lottery tickets 406 onto the spool 780; and (6) a controller (not shown) configured to receive and/or send signals to one or more of other components of the draw lottery ticket scanning assembly 400 and to control the electric drive motor. The spool holder 730 is configured to support a removable storage spool such as spool 780.

The controller 800 can be any suitable type of automatic electrical or electronic computing device or circuit board. For example, in one example embodiment, the controller includes a processor (such as a microprocessor) and a memory device that stores a plurality of instructions, which when executed by the processor, cause the above-described components to function a described herein. The processor can include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine. The memory device can include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media. The memory device stores instructions executable by the processor to control the operation of the lottery ticket scanning assembly 400. In another example embodiment, the controller includes an electric circuit hard wired to perform the necessary functions or determinations described herein.

The lottery ticket scanning assembly 400 and particularly the draw lottery ticket feeder 500, the draw lottery ticket scanner 600, and the draw lottery ticket rewinder 700 are configured to operate to control the movements of the sheet of connected draw lottery tickets 406 such that when each draw lottery ticket is in the draw lottery ticket scanner 600 in a ticket imagining position, it is stationary for a sufficient period of time such that the draw lottery ticket scanner 600 can take a clear image of the entire printed digital lottery ticket.

It should be appreciated from the above that various embodiments of the preset disclosure provide a lottery ticket selling system comprising: (1) an electronic ticket courier server; (2) a wager details display device; (3) a lottery terminal with a scanner; (4) a draw lottery ticket printer positioned to sequentially print a plurality of draw lottery tickets on an elongated sheet of a paper such that the plurality of draw lottery tickets are connected draw lottery tickets; and (5) a draw lottery ticket scanning assembly comprising: (a) a draw lottery ticket feeder positioned to receive the connected draw lottery tickets from the draw lottery ticket printer, (b) a draw lottery ticket scanner positioned to sequentially receive from the draw lottery ticket feeder and scan each of the draw lottery tickets of the connected draw lottery tickets, and (c) a draw lottery ticket rewinder positioned to receive from the draw lottery ticket scanner each of the draw lottery tickets of the connected draw lottery tickets and to rewind the connected draw lottery tickets on a storage spool. In various such embodiments, the draw lottery ticket printer, the draw lottery ticket feeder, the draw lottery ticket scanner, and the draw lottery ticket rewinder are positioned to cause each of the sequentially printed draw lottery tickets to be: (i) fed into the draw lottery ticket feeder, (ii) maintained in the ticket feeder until the draw lottery ticket scanner is ready to receive that printed lottery ticket, (iii) fed into the draw lottery ticket scanner after the draw lottery ticket scanner is ready to receive that draw lottery ticket, (iv) stopped in the scanner to enable the draw lottery ticket scanner to obtain an image of that draw lottery ticket, (v) scanned by the draw lottery ticket scanner such that the draw lottery ticket scanner can create and send draw lottery ticket scan data to the courier server to enable the courier server to provide such image of the draw lottery ticket to a purchaser of the draw lottery ticket, (vi) fed out of the draw lottery ticket scanner after the draw lottery ticket is scanned, and (vii) fed to the draw lottery ticket rewinder such that the draw lottery ticket rewinder can wind the draw lottery ticket on a removable storage spool. In various such embodiments, the draw lottery ticket printer, the draw lottery ticket feeder, the draw lottery ticket scanner, and the draw lottery ticket rewinder are positioned to enable the draw lottery ticket printer to continuously print the draw lottery tickets on the elongated sheet of paper from a supply roll. In various such embodiments, the draw lottery ticket printer, the draw lottery ticket feeder, the draw lottery ticket scanner, and the draw lottery ticket rewinder are positioned to enable the draw lottery ticket printer to print and stop printing the draw lottery tickets on the elongated sheet from a supply roll on a regular basis. In various such embodiments, the draw lottery ticket printer, the draw lottery ticket feeder, the draw lottery ticket scanner, and the draw lottery ticket rewinder are positioned to enable the draw lottery ticket printer to print and stop printing the draw lottery tickets on the elongated sheet from a supply roll on an irregular basis. In various such embodiments, the draw lottery ticket printer, the draw lottery ticket feeder, the draw lottery ticket scanner, and the draw lottery ticket rewinder are positioned to enable the draw lottery ticket scanner to scan each of the connected draw lottery tickets after that draw lottery ticket is received from the draw lottery ticket feeder and stopped in the draw lottery ticket scanner to enable the scanning of that draw lottery ticket by the draw lottery ticket scanner. In various such embodiments, the draw lottery ticket feeder comprises a frame, one or more rotatable non-driven guide rollers supported by the frame, one or more rotatable drive rollers supported by the frame, and one or more stationary guides supported by the frame. In various such embodiments, the draw lottery ticket feeder is between the draw lottery ticket printer and the draw lottery ticket scanner. In various such embodiments, the lottery ticket selling system comprises a second draw lottery ticket feeder between the draw lottery ticket scanner and the draw lottery ticket rewinder. In various such embodiments, the draw lottery ticket scanner comprises a scanner housing and a digital camera supported by the scanner housing. In various such embodiments, the draw lottery ticket scanner comprises a scanner housing and a scanner supported by the scanner housing. In various such embodiments, the draw lottery ticket rewinder comprises a base, a support connected to and extending upwardly from the base, a drive motor supported by the support, and a rotatable spool holder connected to and supported by the drive motor.

It should further be appreciated from the above that various embodiments of the preset disclosure provide a lottery ticket selling system comprising: (1) an electronic ticket courier server; (2) a wager details display device; (3) a lottery terminal with a scanner; (4) a draw lottery ticket printer positioned to sequentially print a plurality of draw lottery tickets on an elongated sheet of a paper such that the plurality of draw lottery tickets are connected draw lottery tickets; and (5) a draw lottery ticket scanning assembly comprising: (1) a draw lottery ticket feeder positioned to receive the connected draw lottery tickets from the draw lottery ticket printer, the draw lottery ticket feeder comprising a frame, a plurality of rotatable non-driven guide rollers supported by the frame, a plurality of rotatable drive rollers supported by the frame, and a plurality of stationary guides supported by the frame, (2) a draw lottery ticket scanner comprising a scanner housing and a digital camera supported by the scanner housing, the draw lottery ticket scanner positioned to sequentially receive from the draw lottery ticket feeder and scan each of the connected draw lottery tickets, and (3) a draw lottery ticket rewinder comprising a base, a support connected to and extending upwardly from the base, a drive motor supported by the support, and a rotatable spool holder connected to and supported by the drive motor, the draw lottery ticket rewinder positioned to receive from the draw lottery ticket scanner each of the connected draw lottery tickets and to rewind each of the connected draw lottery tickets on a storage spool. In various such embodiments, the draw lottery ticket printer, the draw lottery ticket feeder, the draw lottery ticket scanner, and the draw lottery ticket rewinder are positioned to cause each of the connected draw lottery tickets to be: maintained in the ticket feeder until the draw lottery ticket scanner is ready to receive that printed lottery ticket, fed into the draw lottery ticket scanner after the draw lottery ticket scanner is ready to receive that draw lottery ticket, and stopped to enable the draw lottery ticket scanner to obtain a clear image of that printed draw lottery ticket. In various such embodiments, the draw lottery ticket printer, the draw lottery ticket feeder, the draw lottery ticket scanner, and the draw lottery ticket rewinder are positioned to enable the draw lottery ticket printer to continuously print the connected draw lottery tickets on the elongated sheet from a supply roll. In various such embodiments, the draw lottery ticket printer, the draw lottery ticket feeder, the draw lottery ticket scanner, and the draw lottery ticket rewinder are positioned to enable the draw lottery ticket printer to print and stop printing the connected draw lottery tickets on the elongated sheet from a supply roll on a regular basis. In various such embodiments, the draw lottery ticket printer, the draw lottery ticket feeder, the draw lottery ticket scanner, and the draw lottery ticket rewinder are positioned to enable the draw lottery ticket printer to print and stop printing the connected draw lottery tickets on the elongated sheet from a supply roll on an irregular basis.

It should further be appreciated from the above that various embodiments of the preset disclosure provide a lottery ticket selling system comprising: (1) an electronic ticket courier server; (2) a wager details display device; (3) a lottery terminal with a scanner; (4) a draw lottery ticket printer positioned to sequentially print a plurality of draw lottery tickets on an elongated sheet of a paper such that the plurality of draw lottery tickets are connected draw lottery tickets; and (5) a draw lottery ticket scanning assembly comprising: (a) a draw lottery ticket feeder, (b) a draw lottery ticket scanner, and (c) a draw lottery ticket rewinder, wherein the draw lottery ticket printer, the draw lottery ticket feeder, the draw lottery ticket scanner, and the draw lottery ticket rewinder are positioned to cause each sequentially printed connected draw lottery ticket to be: (i) fed into the draw lottery ticket feeder, (ii) maintained in the ticket feeder until the draw lottery ticket scanner is ready to receive that printed lottery ticket, (iii) fed into the draw lottery ticket scanner after the draw lottery ticket scanner is ready to receive that draw lottery ticket, (iv) stopped in the draw lottery ticket scanner to enable the draw lottery ticket scanner to obtain an image of that printed draw lottery ticket, (v) fed out of the draw lottery ticket scanner after the draw lottery ticket is scanned, and (vi) fed to the draw lottery ticket rewinder such that the draw lottery ticket rewinder can wind the draw lottery ticket on a removable storage spool. In various such embodiments, the draw lottery ticket printer, the draw lottery ticket feeder, the draw lottery ticket scanner, and the draw lottery ticket rewinder are positioned to enable the draw lottery ticket printer to continuously print the connected draw lottery tickets on the elongated sheet from a supply roll. In various such embodiments, the draw lottery ticket printer, the draw lottery ticket feeder, the draw lottery ticket scanner, and the draw lottery ticket rewinder are positioned to enable the draw lottery ticket printer to print and stop printing the connected draw lottery tickets on the elongated sheet from a supply roll on a regular basis or an irregular basis.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A lottery ticket selling system comprising:
an electronic ticket courier server;
a wager details display device;
a lottery terminal with a scanner;
a draw lottery ticket printer positioned to sequentially print a plurality of draw lottery tickets on an elongated sheet of a paper such that the plurality of draw lottery tickets are connected draw lottery tickets; and
a draw lottery ticket scanning assembly comprising:
a draw lottery ticket feeder positioned to receive the connected draw lottery tickets from the draw lottery ticket printer,
a draw lottery ticket scanner positioned to sequentially receive from the draw lottery ticket feeder and scan each of the draw lottery tickets of the connected draw lottery tickets, and
a draw lottery ticket rewinder positioned to receive from the draw lottery ticket scanner each of the draw lottery tickets of the connected draw lottery tickets and to rewind the connected draw lottery tickets on a storage spool.

2. The lottery ticket selling system of claim 1, wherein the draw lottery ticket printer, the draw lottery ticket feeder, the draw lottery ticket scanner, and the draw lottery ticket rewinder are positioned to cause each of the sequentially printed draw lottery tickets to be:
fed into the draw lottery ticket feeder,
maintained in the ticket feeder until the draw lottery ticket scanner is ready to receive that printed lottery ticket,
fed into the draw lottery ticket scanner after the draw lottery ticket scanner is ready to receive that draw lottery ticket,
stopped in the scanner to enable the draw lottery ticket scanner to obtain an image of that draw lottery ticket,
scanned by the draw lottery ticket scanner such that the draw lottery ticket scanner can create and send draw lottery ticket scan data to the courier server to enable the courier server to provide such image of the draw lottery ticket to a purchaser of the draw lottery ticket,
fed out of the draw lottery ticket scanner after the draw lottery ticket is scanned, and
fed to the draw lottery ticket rewinder such that the draw lottery ticket rewinder can wind the draw lottery ticket on a removable storage spool.

3. The lottery ticket selling system of claim 1, wherein the draw lottery ticket printer, the draw lottery ticket feeder, the draw lottery ticket scanner, and the draw lottery ticket rewinder are positioned to enable the draw lottery ticket printer to continuously print the draw lottery tickets on the elongated sheet of paper from a supply roll.

4. The lottery ticket selling system of claim 1, wherein the draw lottery ticket printer, the draw lottery ticket feeder, the draw lottery ticket scanner, and the draw lottery ticket rewinder are positioned to enable the draw lottery ticket printer to print and stop printing the draw lottery tickets on the elongated sheet from a supply roll on a regular basis.

5. The lottery ticket selling system of claim 1, wherein the draw lottery ticket printer, the draw lottery ticket feeder, the draw lottery ticket scanner, and the draw lottery ticket rewinder are positioned to enable the draw lottery ticket printer to print and stop printing the draw lottery tickets on the elongated sheet from a supply roll on an irregular basis.

6. The lottery ticket selling system of claim 1, wherein the draw lottery ticket printer, the draw lottery ticket feeder, the draw lottery ticket scanner, and the draw lottery ticket rewinder are positioned to enable the draw lottery ticket scanner to scan each of the connected draw lottery tickets after that draw lottery ticket is received from the draw lottery ticket feeder and stopped in the draw lottery ticket scanner to enable the scanning of that draw lottery ticket by the draw lottery ticket scanner.

7. The lottery ticket selling system of claim 1, wherein the draw lottery ticket feeder comprises a frame, one or more rotatable non-driven guide rollers supported by the frame, one or more rotatable drive rollers supported by the frame, and one or more stationary guides supported by the frame.

8. The lottery ticket selling system of claim 1, wherein the draw lottery ticket feeder is between the draw lottery ticket printer and the draw lottery ticket scanner.

9. The lottery ticket selling system of claim 8, which comprises a second draw lottery ticket feeder between the draw lottery ticket scanner and the draw lottery ticket rewinder.

10. The lottery ticket selling system of claim 1, wherein the draw lottery ticket scanner comprises a scanner housing and a digital camera supported by the scanner housing.

11. The lottery ticket selling system of claim 1, wherein the draw lottery ticket scanner comprises a scanner housing and a scanner supported by the scanner housing.

12. The lottery ticket selling system of claim 1, wherein the draw lottery ticket rewinder comprises a base, a support connected to and extending upwardly from the base, a drive motor supported by the support, and a rotatable spool holder connected to and supported by the drive motor.

13. A lottery ticket selling system comprising:
an electronic ticket courier server;
a wager details display device;
a lottery terminal with a scanner;
a draw lottery ticket printer positioned to sequentially print a plurality of draw lottery tickets on an elongated sheet of a paper such that the plurality of draw lottery tickets are connected draw lottery tickets; and
a draw lottery ticket scanning assembly comprising:
a draw lottery ticket feeder positioned to receive the connected draw lottery tickets from the draw lottery ticket printer, the draw lottery ticket feeder comprising a frame, a plurality of rotatable non-driven guide rollers supported by the frame, a plurality of rotatable drive rollers supported by the frame, and a plurality of stationary guides supported by the frame,
a draw lottery ticket scanner comprising a scanner housing and a digital camera supported by the scanner housing, the draw lottery ticket scanner positioned to sequentially receive from the draw lottery ticket feeder and scan each of the connected draw lottery tickets, and
a draw lottery ticket rewinder comprising a base, a support connected to and extending upwardly from the base, a drive motor supported by the support, and a rotatable spool holder connected to and supported by the drive motor, the draw lottery ticket rewinder positioned to receive from the draw lottery ticket scanner each of the connected draw lottery tickets and to rewind each of the connected draw lottery tickets on a storage spool.

14. The lottery ticket selling system of claim 13, wherein the draw lottery ticket printer, the draw lottery ticket feeder, the draw lottery ticket scanner, and the draw lottery ticket rewinder are positioned to cause each of the connected draw lottery tickets to be:
maintained in the ticket feeder until the draw lottery ticket scanner is ready to receive that printed lottery ticket,
fed into the draw lottery ticket scanner after the draw lottery ticket scanner is ready to receive that draw lottery ticket, and
stopped to enable the draw lottery ticket scanner to obtain a clear image of that printed draw lottery ticket.

15. The lottery ticket selling system of claim 13, wherein the draw lottery ticket printer, the draw lottery ticket feeder, the draw lottery ticket scanner, and the draw lottery ticket rewinder are positioned to enable the draw lottery ticket printer to continuously print the connected draw lottery tickets on the elongated sheet from a supply roll.

16. The lottery ticket selling system of claim 13, wherein the draw lottery ticket printer, the draw lottery ticket feeder, the draw lottery ticket scanner, and the draw lottery ticket rewinder are positioned to enable the draw lottery ticket printer to print and stop printing the connected draw lottery tickets on the elongated sheet from a supply roll on a regular basis.

17. The lottery ticket selling system of claim 13, wherein the draw lottery ticket printer, the draw lottery ticket feeder, the draw lottery ticket scanner, and the draw lottery ticket rewinder are positioned to enable the draw lottery ticket printer to print and stop printing the connected draw lottery tickets on the elongated sheet from a supply roll on an irregular basis.

18. A lottery ticket selling system comprising:
an electronic ticket courier server;
a wager details display device;
a lottery terminal with a scanner;
a draw lottery ticket printer positioned to sequentially print a plurality of draw lottery tickets on an elongated sheet of a paper such that the plurality of draw lottery tickets are connected draw lottery tickets; and
a draw lottery ticket scanning assembly comprising:
a draw lottery ticket feeder,
a draw lottery ticket scanner, and
a draw lottery ticket rewinder,
wherein the draw lottery ticket printer, the draw lottery ticket feeder, the draw lottery ticket scanner, and the draw lottery ticket rewinder are positioned to cause each sequentially printed connected draw lottery ticket to be:
fed into the draw lottery ticket feeder,
maintained in the ticket feeder until the draw lottery ticket scanner is ready to receive that printed lottery ticket,
fed into the draw lottery ticket scanner after the draw lottery ticket scanner is ready to receive that draw lottery ticket,
stopped in the draw lottery ticket scanner to enable the draw lottery ticket scanner to obtain an image of that printed draw lottery ticket,
fed out of the draw lottery ticket scanner after the draw lottery ticket is scanned, and
fed to the draw lottery ticket rewinder such that the draw lottery ticket rewinder can wind the draw lottery ticket on a removable storage spool.

19. The lottery ticket selling system of claim 18, wherein the draw lottery ticket printer, the draw lottery ticket feeder, the draw lottery ticket scanner, and the draw lottery ticket rewinder are positioned to enable the draw lottery ticket printer to continuously print the connected draw lottery tickets on the elongated sheet from a supply roll.

20. The lottery ticket selling system of claim 18, wherein the draw lottery ticket printer, the draw lottery ticket feeder, the draw lottery ticket scanner, and the draw lottery ticket rewinder are positioned to enable the draw lottery ticket printer to print and stop printing the connected draw lottery tickets on the elongated sheet from a supply roll on a regular basis or an irregular basis.
